(19) United States
(12) Patent Application Publication
(10) Pub. No.: US 2003/0139996 A1
(43) Pub. Date: Jul. 24, 2003

(54) Business method for facilitating the sale of goods and services

(76) Inventors: David D'Antoni, Dublin, OH (US); Michael Portland, Dublin, OH (US)

Correspondence Address: WOOD, HERRON & EVANS, L.L.P., 2700 Carew Tower, Cincinnati, OH, 45202, US

(21) Appl. No.: 09/877,154

(22) Filed: Jun. 8, 2001

Related U.S. Application Data
(60) Provisional application No. 60/212,611, filed on Jun. 19, 2000.

(51) Int. Cl. G06F 17/60

(52) U.S. Cl. 705/37

(57) ABSTRACT

A method for facilitating the purchase of goods and services of a targeted population, typically of medium to small-sized industrial manufacturers, fabricators and others, at a lower total cost. A facilitating entity establishes and acts as the hub of a trading network and provides multiple value-added services to facilitate trade through that hub. The facilitating entity establishes business relationships with selected suppliers of goods and services and with business partners. The facilitating entity negotiates attractive prices with the suppliers given the volume purchases of its business partners and of the business partner customers. The facilitating entity also establishes an information processing system that provides access to the trading network's suppliers by the business partners and the business partner customers and their employees. The resulting arrangement is mutually beneficial to the business partners, customers and suppliers, enabling all three to realize increased efficiencies and profitability.

### CROSS-REFERENCE TO RELATED APPLICATION

The application is a continuation of U.S. provisional application serial number 60/212,611, filed Jun. 19, 2000, having the same title and naming the same inventors as the present application, which provisional applications is hereby incorporated by reference in its entirety.

### FIELD OF THE INVENTION

The present invention relates to the sale of goods and services utilizing electronic communication media such as the Internet.

### BACKGROUND OF THE INVENTION

Over the past several years electronic commerce (e-commerce) has grown exponentially. Much of this growth has been in the area of business by consumer marketing. Recently, e-commerce technology has begun to be used in the business to business markets. Industry experts expect by the year 2003, business to business e-commerce will exceed $1.3 trillion in sales. This growth is facilitated by several trends. A first factor is the development of information systems capable of automating business transactions via the Internet, on both the client and server side. Client software such as Internet browsers has become increasingly sophisticated and incorporates features such as password and form management that facilitate e-commerce. Server software useable to establish an e-commerce is now readily available to even small businesses. As a consequence, many suppliers have established e-commerce sites for their customers and experience increasing sales volume through these sites. Another factor is growth in the number of small to medium sized businesses that have access to and use the Internet, as a consequence of reduced costs for computer hardware and Internet access. A third factor is the emergence of electronic marketplaces in which users may electronically buy and sell desired goods and services through bundled offerings.

Small businesses are the fastest growing segment of the United States economy. Thus, the market for small business purchases is a large market that is growing rapidly. Therefore, it is of interest to suppliers, particularly suppliers of “indirect” material and services. “Indirect” materials include worldwide non-production services such as telephone, travel, and Internet access. Industry reports indicate that indirect expenditures may account for 10-30% percent of a small company's total revenues. Thus, small businesses represent a significant marketing opportunity for suppliers of indirect materials. Also, small businesses have a significant opportunity for increasing profitability by controlling expenditures for indirect materials. These businesses, however, face a number of challenges in reducing the indirect spending, including the following: Small businesses tend to have little negotiation leverage with suppliers, and in many cases buy at listed catalog prices. Procurement processes of small businesses tend to be less sophisticated, and thus, expenditures are often poorly controlled. Lack of control leads to significant off-contract or “maverick” buying which can account for as much as 40% of all expenditures. Expenditures are primarily low dollar value purchases that are comparatively costly to process, with order processing costs often exceeding the price of the items purchased.

While the growth of e-commerce has had an effect on small to medium size businesses within the United States, it has had limited impact on the profitability of these businesses, for several reasons. Historically, these businesses have faced a variety of competitive challenges including competing in highly fragmented industries, limited supply chain leverage and limited access to capital. E-commerce by itself cannot effectively alter these business realities. In addition, for many industrial suppliers, these smaller companies require a higher cost to sell and service, and therefore must be charged premium prices for supplied goods or services to recoup the costs of this sales and service effort. While e-commerce reduces the costs of sales and service for all customers, it cannot change the relative cost of sales and service for small and medium size businesses as compared to large businesses, and thus cannot substantially change the relative price disadvantages faced by small and medium sized businesses.

To attempt to curtail costs, small businesses may join one of several known buyer's organizations. A buyer's organization typically charges a membership fee, and in exchange for this fee, negotiates discounts with various vendors typically used by its members. Buyer's organizations are often created through other organizations, such as trade associations, which have a number of members with similar buying patterns, for the reason that it is difficult to collect a sufficiently large group of similar buyers without such a pre-existing organization. Suppliers are willing to negotiate discount prices with buyer's organizations for the reason that the buyer's organization will provide advertising to its members identifying the supplier's goods or services, and thereby direct additional, hard to reach customers to the supplier.

Unfortunately many buyer's organizations are too small to negotiate significant discounts or to provide discounts for the wide variety of goods and services, particularly indirect supplies, required by a typical small to medium sized business. While a small or medium sized business may join several buyers organizations to increase the range of available discounts, doing so elevates the administrative expense of maintaining multiple memberships, as well as the expense of identifying the availability of discounts and the appropriate buyer's organization through which the discounts can be obtained, and evaluating the cost and benefit of joining a particular buyer's organization. As a consequence, buyer's organizations have had only limited success.

Businesses, and particularly small businesses, would therefore substantially benefit from access to a procurement solution that reduces the total cost of expenditures by managing these challenges.

### SUMMARY OF THE INVENTION

In accordance with principles of the present invention, a business method is provided for facilitating the purchase of goods and services of a targeted population, typically of medium to small-sized industrial manufacturers, fabricators and others. This business method is based upon a model that leverages current market environments to enable primarily medium to small sized customers of relatively large suppliers to electronically purchase goods and services produced by suppliers at a lower total cost.

Specifically, the business method is a system administered by a Facilitating Entity that establishes and acts as the hub of a trading network and provides multiple value-added services to facilitate trade through that hub. The Facilitating Entity establishes business relationships with selected Suppliers of goods and services and with Business Partners, which are typically companies with a large number of primarily medium and small Customers. The Facilitating Entity negotiates attractive prices with the Suppliers given the volume purchases of its Business Partners and of the Business Partner Customers. The Facilitating Entity also establishes an information processing system that provides access to the trading network's Suppliers by the Business Partners and the Business Partner Customers and their Employees. The information processing system can either be a proprietary system or a modified version of a commercially available eCommerce marketplace system.

The Facilitating Entity also provides a complete package of services to facilitate trade through the network. These services include sales and marketing materials and processes to be used by the Business Partner's sales force and the Facilitating Entity sales function to register Business Partner Customers into the trading network. Sales history and purchase detail reporting are other services provided by the Facilitating Entity to those ordering through the network. Once the network of Suppliers the information processing system, and related services are in place, the Facilitating Entity can quickly attract, and enlist other Business Partners and their Customers to add to this complete trading network.

The resulting arrangement is mutually beneficial to Customers, Business Partners, and Suppliers.

A specific disclosed mode for conducting business between buyers and sellers of Products using the System administered by the Facilitating Entity permits a User affiliated with a Customer, to electronically enter an order for a Product of a Supplier participating in the System, for an established price, where the Facilitating Entity: (1) selects the Supplier who participate in the System; (2) provides an electronic means by which Users access Information related to the Products of the Suppliers of the System; (3) negotiates established prices for Products of the Suppliers of the System; and/or (4) stores and processes Information.

By serving these functions, the Facilitating Entity can facilitate business among the participants in the System. The Facilitating Entity may enroll Customers by selecting Business Partners and Customers of those Business Partners. Alternatively, the Facilitating Entity may enroll Customers directly, without selecting or involving Business Partners.

In the specific embodiments described herein, only those parties that are Customers of the Business Partners are provided access to the discounted price negotiated by the Facilitating Entity. As a consequence, the negotiated discounted prices have a limited availability, which targets and limits the market place participation for the Suppliers, and increases their likelihood of agreeing to negotiated discounts. Customers thus obtain the benefit of reduced absolute costs. Business Partners are benefitted by an increase in the affinity of their Customers for the Business Partners and the goods or services purchased from the Business Partners. Business Partners can also benefit from the relationships the Facilitating Entity has established with Suppliers by realizing better pricing than if they chose to buy their own indirect goods and services from Suppliers outside the network. Suppliers obtain the benefit of advertising and marketing assistance an access to a large number of attractive but hard to reach small and medium sized Customers, which is reflected in lower pricing.

The Business Partners may provide this service free of charge to their Customers, thus enhancing the appeal of the service to Customers and affinity of Customers to Business Partners. Alternatively, a fee may be charged to Customers for participation. As a further service, the Business Partners may establish an electronic purchasing and information site through which Products of any or all of the Suppliers may be made available for purchase by a Customer. Suppliers will realize the benefit of reduced administrative expense as the collection of orders and delivery of status Information is handled by the information processing system of the Facilitating Entity, rather than being the responsibility of the Supplier. Business Partners obtain the benefit of centralized accounting systems for tracking the performance of their involvement with the Facilitating Entity and participation by Customers. As part of the agreements linking the Suppliers to the trade network, provisions can be made for a sales/marketing commission to the Facilitating Entity in consideration for access to the Customers.

As a direct financial incentive to Business Partners, the Facilitating Entity may elect to make a portion of the sales commission payable to the Business Partner(s) for each Product sold to Business Partner Customers. The commission revenue that is thereby generated may be paid to the Business Partner responsible for the inclusion of the Customer in the program, i.e., the Business Partner that had an existing business relationship with the Customer. Alternatively, the commissions may be divided among the Business Partners, for example on a pro-rata basis upon the number of Customers of each Business Partner, or in any other manner.

The discounts negotiated by the Facilitating Entity for the Customers may relate to indirect goods and services that are not used in the production of goods and services by the Customers, or may relate to direct goods and services that are used by Customers in the production of goods and services. Similarly, the discounts may be negotiated with Suppliers to a horizontal market that may include Customers of multiple Business Partners, or alternatively, the Suppliers may be Suppliers to a vertical market.

In this specific embodiment, to provide further added value for Customers, the Facilitating Entity may negotiate with an employee services provided to provide employee services, e.g., access to employee health insurance, discounted entertainment or travel, to Employees of Customers of Business Partners or Employees of the Business Partners themselves. This has the benefit of provided the Customer with access to employee services that might otherwise be unavailable or costly to obtain. The Business Partners realized the benefit of increasing the affinity of Customers and particularly the Employees of the Customers, to the Business Partners. The employee services provider obtains advertising and marketing assistance directed to attractive but hard to reach small and medium sized Customers. This benefit to the employee service provider is reflected in lower pricing for such services for Customers, and/or payment of commissions of “finder's fees” to the Facilitating Entity, which may or may not be shared with the Business Partners in various ways as noted above.

The Business Partners may make access to the Facilitating Entity available to all Customers without restriction, or may establish criteria upon Customers to access the Facilitating Entity. These requirements may be established for all Customers, or may be uniquely established by each Business Partner and be applicable to Customers of that Business Partner. Additionally, Suppliers may also establish credit requirements upon Customers to ensure that Customers' participating in the system are acceptable credit risks to the Suppliers.

Business Partners may be added at any time, providing their Customers access to the Facilitating Entity. For example, Suppliers from whom discounted pricing has been negotiated, may become Business Partners, in which case Customers of the Supplier will obtain access to discounted pricing that has been negotiated with other Suppliers. To maintain revenues from existing customers, a Supplier that also is a Business Partner may refuse to provide discounted pricing on its goods and services to all its customers that are not Customers of another Business Partner.

Applying this business method, it can be seen that the Facilitating Entity can establish a network of relationships of mutual benefit to the Facilitating Entity, Business Partners, Suppliers and Customers, for a targeted population of primarily small to medium sized business consumer of goods and services and their Employees.

The above and other objects from the accompanying the drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a schematic illustration of Supplier-customer relationships in accordance with current business models and practices;

FIG. 2 is an illustration of Supplier-Customer relationships in accordance with principles of the present invention;

FIG. 3 is an illustration of the arrangement of computer systems utilized in a particular embodiment of the present invention;

FIG. 4 is an illustration of organizational relationships and data structures established in administration of the present invention by the buy site and market site of FIG. 3.

FIG. 4A, 4B, 4C and 4D are illustrations of the data structures used at the buy site and market site of FIG. 3 in administration of the present invention.

FIG. 5A is a flow chart of the activities of a Customer interacting with the Customer interface of the buy site of FIG. 3, and FIG. 5B is a flow chart of the activities of a Customer interacting with the buy site of FIG. 3, in performing commercial transactions in accordance with principles of the present invention.

### DETAILED DESCRIPTION OF SPECIFIC EMBODIMENTS

As an initial matter, we will provide definitions of parties to the novel business relationships and commercial systems that are the subject of the present application. These parties include

A Facilitating Entity FE is the entity that administers the System, negotiates with and enlists Business Partners BP and Suppliers S into the network, enrolls Customers C of Business Partners BP into the System and/or directly enrolls Customers. The Facilitating Entity is typically independent from the Business Partners, Suppliers and/or Customers, but may be affiliated with one or more of them;

Business Partners BP are businesses, selected by the Facilitating Entity to participate in the System, that provide goods and services to Customers who are authorized to participate in the system;

Customers C are purchasers of Products, and may be customers of one or more of the Business Partners who are authorized to use the System, or may be directly selected or enrolled by the Facilitating Entity FE;

Information is information related to the Business Partners, Suppliers, Customers, Products, orders by Users, sales that result from orders, and/or other information that the Facilitating Entity can use to facilitate business among the participant of the System;

Products are good(s) and or service(s) provided by a Supplier;

Supplier members S are businesses that supply Products to Customers C;

Users are Employees or other persons associated with a Customer, who the Customer authorized to make purchases using the System or otherwise use the system for business purposes;

Employees are employees of Customers who are authorized to use the System for their personal benefit; and

The System or “sourceXplorer.com” SX System is an electronic market site for conducting business, devised and administered by the Facilitating Entity, that connects to Suppliers S and to Customers C to facilitate purchases of goods and services by Customers C, and collects and generates reports of transaction Information between Customers C and Suppliers S that involve the use of the SX system, as well as generating financial Information from these transactions for use in delivering commissions to the Business Partners BP.

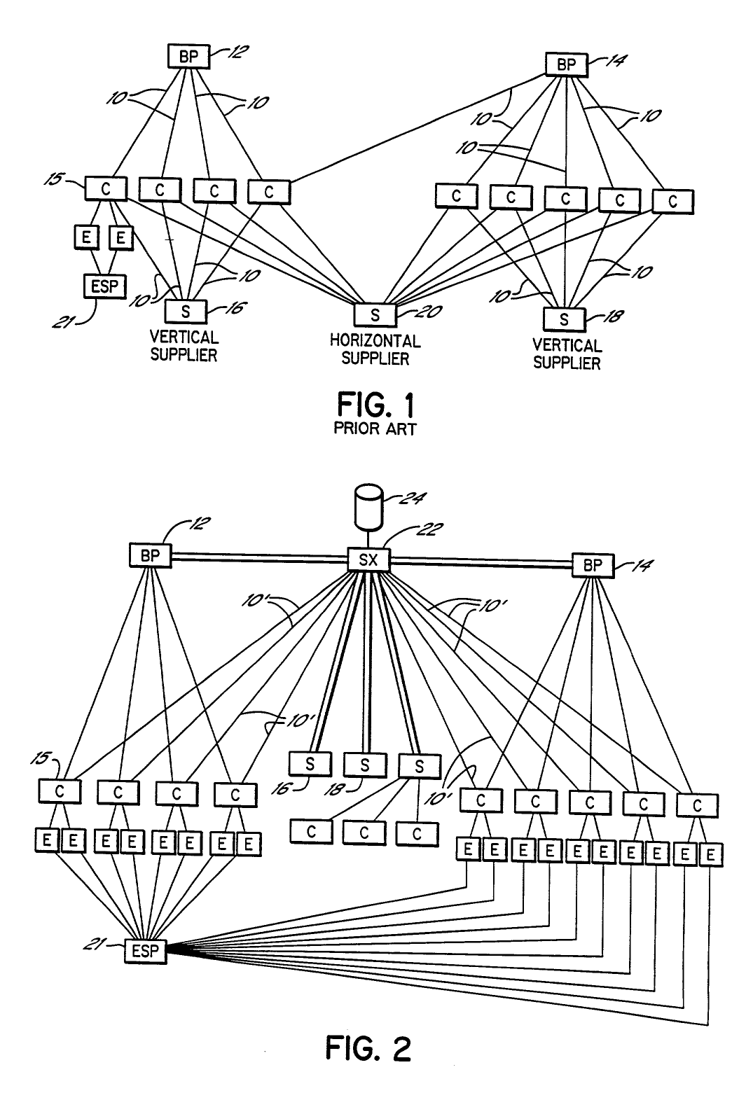

Referring to FIG. 1, the Customer and Supplier relationships in a typical business to business environment can be explained. In this illustration, a plurality of Customers C, which may be small manufacturing business or other competitors in a given marketplace, have business relationships with a number of vendors for various Products, which include both vendors that, in accordance with the invention, are prospective Business Partners BP, as well as other vendors that are prospective Supplies S. A business relationship is represented in FIG. 1 by a line 10 between a Customer C and Supplier S or potential Business Partner BP As can be seen, Customers C have vendor relationships with a number of other entities from whom they purchase both direct and indirect goods. For example, the Customers C illustrated in FIG. 1, each have a relationship with one of the Business Partners 12 or 14 through which those Customers purchase goods, e.g. direct or indirect goods used in the manufacture of provision of goods and services to Customer C. In addition, the Customers C have relationships with Suppliers S. Suppliers may be a vertical Supplier such as Suppliers 16 and 18, or may be a horizontal Supplier such as Supplier 20. Vertical Suppliers 16, 18 are characterized by provision of industry specific goods, whereas horizontal Suppliers such as 20 are characterized by the provision of goods that are utilized across a variety of industries, such as office supplies.

As a concrete example of a business relationship model similar to that shown in FIG. 1, Business Partner 12 may be a chemical and plastic Products Supplier such as Ashland Inc., a corporation that provides chemicals and plastics to a variety of large, medium and small sized businesses, but is unique in its large number of relationships with medium and small sized business entities. Customers of Business Partner 12 may include chemical processing plants or chemical users such as semiconductor manufacturers or other manufacturers that consume plastics such as plastic molders. Customers of Business Partner 12 will utilize other Suppliers of both direct and indirect goods. A common example for indirect Suppliers relationships is relationships for the purchase of office supplies used by the Customer. In this example, Supplier 20 would be a Supplier of office supplies such as paper, pencils, paperclips, folders, filing cabinets and the like. Supplier 20 is known as a horizontal Supplier because the Products that is supplies are utilized across a variety of industries that are not unique to Customers of chemical Product manufacturers. Customers of Business Partner 12 may also utilize a number of vertical Suppliers such as Supplier 16 to purchase molding equipment, molding software, and other goods or services unique to their business line. Chemical manufacturers that distribute Products to consumer markets may purchase packaging unique for chemical packaging from packaging Suppliers. Semiconductor manufacturers may purchase specific electronic equipment utilized in the manufacturing process and unique to the industry.

FIG. 1 illustrates a second potential Business Partner 14, which for the sake of the current example would be another corporate Supplier of Products to a relatively large number of Customers of primarily small and medium size. One specific example of another organization of the type is an integrated machine tool or fastener Supplier.

An important criteria for a Business Partner is that it have a large number of small to medium size Customers, because those Customers are most likely to benefit from participation by the Business Partner in the inventive method.

Business Partners will most likely come likely come from markets which are fragmented with high levels of competition. Leaders in these industries, from which Business Partners would be chosen, compete based upon their knowledge of the Products, processes and market conditions.

As leaders within their markets, prospective Business Partners will maintain strong relationships with a selected Customer base of primarily small to medium sized industrial businesses. The Business Partners will generally operate a direct sales force to serve these Customers. In addition, the Business Partners will likely have, or be near the initial stages of having their own e-commerce initiatives, focusing on providing their Customers with means to purchase traditional Products and service via the Internet.

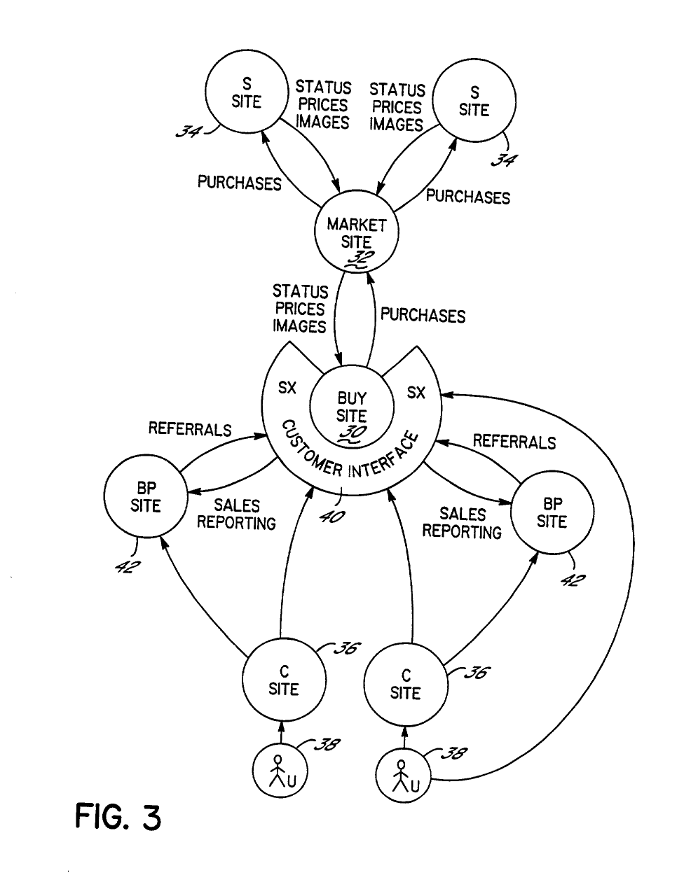

Referring now to FIG. 2, the rearrangement of relationships achieved through principles of the present invention can be more readily understood. In this illustration, a network has been formed between each the prospective Business Partners BP 12 and 14 shown in FIG. 1 and an independent Facilitating Entity (IFE) which establishes a common administrative service, hereafter know as the “sourceXplorer.com” or SX system 22, for facilitating relationships between the Customers of the Business Partners and the Suppliers S enlisted by the independent Facilitating Entity. The SX system facilitates these relationships by providing a cohesive e-commerce interface to goods of Suppliers S using a large database 24 of Supplier Product, pricing and contact Information, as well as Customer contact and payment Information, as is detailed substantially in the following figures.

To establish the system, the IFE negotiates for reduced pricing with a number of Suppliers S. This may be best done by negotiating with Suppliers of indirect Products that act in horizontal markets such as Supplier 20, since such Suppliers will be immediately eligible for the aggregate business of most if not all of the Customers C of all of the Business Partners, and thus can be more readily enticed into a discount arrangement. An exemplary Supplier for such an initial arrangement is a Supplier of office supplies or other indirect Products. Other exemplary indirect, horizontal market Products include: electrical supplies, laboratory equipment, safety equipment, pipes, valves and fittings, travel services, energy (e.g., natural gas, electricity, fuel), automobile leasing services, financial services, environment, health and safety services, uniforms, hand tools, telecommunications services, power transmission equipment, consulting services, employee discount program providers, and employee benefit providers.

To initiate an arrangement such as illustrated in FIG. 2, the independent Facilitating Entity will establish a core group of horizontal Suppliers for office supplies, electrical supplies, laboratory supplies, safety equipment and pipes, valves and fittings. These particular supplies are estimated to comprise over 20-40% of the total indirect materials purchases of the Customers of the Business Partners in the target markets, and thus represents a significant savings opportunity for those Customers. A single, preferred Suppliers will initially be selected for each of these categories, selected as most likely to provide all Customers with quality, convenience and low price. Criteria for evaluating a Supplier include: Product offering, national presence, e-commerce capabilities, Product pricing, service quality and capabilities, reputation, and financial stability.

After establishing discounts with a core group of Suppliers S, the independent Facilitating Entity will develop the SX system 22 and database 24. Next, the IFE will obtain agreements with the Business Partners and the Business Partners will then solicit their Customers to participate in these discounts by purchasing applicable goods and services through the SX system 22 rather that directly from their existing Suppliers. Target Customers for initiation of the system are small and medium sized U.S. companies that operate in fragmented industries, and generate from $20 and $250 million in annual revenues. Customers at the lower end of this range likely do not support an extensive in-house purchasing function. These businesses are likely to possess limited supply leverage and to have less sophisticated purchasing processes. It is expected that the average Customer of a Business Partner meeting this description, which has revenues between $20 and $50 million, will purchase a total of $500,000 to $1 million of indirect goods and services annually.

Solicitation of existing Customers of Business Partners will be facilitated by the fact that those Customers are likely already serviced by the direct sales force of the Business Partner. These Customers can thus be solicited for participation in the SX system as part of regularly scheduled sales calls, without significant additional expense to the Business Partner.

Target Customers may currently be conducting business in a traditional manner, or may already be suing e-commerce capabilities for business to business purchasing. The latter group could readily transition to electronic ordering through the SX system based upon their existing experience with e-commerce. Others would be motivated, by the availability of discounts through the SX system, to add an e-commerce capability and begin using e-commerce. Others would be motivated, by the availability of discounts through the SX system, to add an e-commerce capability and begin using e-commerce for business to business purchasing both from the Suppliers S and the Business Partner BP. This would have the added benefit that the prospective Business Partners can realize substantial administrative savings by migrating its traditional Customers to electronic ordering. Thus, sign-up and usage of a Business Partner's own commerce functionality with its customers will likely increase as a result of participation in the trading network by the Business Partner, providing an additional incentive for such participation.

Once Customers have initiated a relationship with the SX system, the relationships between Customers and Suppliers will have the arrangement shown in FIG. 2. As seen there, Customers no longer must establish or maintain direct relationships 10 with each of a myriad number of Suppliers, as seen in FIG. 1, but rather have a single relationship 10′ with the SX system as seen in FIG. 2, though which orders may be placed with any one of Suppliers 16, 18 or 20. Customers C and Suppliers S thus realize substantial benefits in efficiency, and Customers C further may establish constraints on alternative purchasing methods used by its own Employees or other buyers, to limit “maverick” buying and thus reduce the total costs of goods purchased by the Customer C.

To further facilitate Customer' use of the SX system and provide further incentives to both Customers C and Suppliers S to participate in the inventive method, the independent Facilitating Entity may negotiate with leading financial institutions to develop a partnership which provides purchasing cards or purchasing credit accounts and/or other services to Customers C. Customers can then purchase Products from Suppliers S through the SX system via myriad payment methods, including direct invoicing from the Supplier, existing credit cards, or partner-facilitated purchasing cards or purchasing credit accounts. As part of the relationship with the independent Facilitating Entity, the financial institution would provide purchasing cards or accounts to all qualified Customers C. The qualification process would be conducted as part of registration of the Customer for use of the system. The Customer would then be able to use the card or account for any purchases through the SX system. Typically, the card would be in the form of a generally accepted credit card so could also be used for other purchases unrelated to the SX system.

The independent Facilitating Entity may continuously work with Customers C to identify and facilitate other payment options. Doing so adds value for Customers C by providing them the ability to flexibly select payment options, better manage, control electronic reconciliation of purchase orders and billing processes, obtain assistance to apply for credit, and lower Customer transaction processing fees.

Developing such financial institution relationships will enable Suppliers to manage their credit risks when participating in the SX system. To support these goals, the SX system would establish a set of credit policies and procedures that would become part of the standard Supplier agreement.

Another service that the independent Facilitating Entity may facilitate for Customers, is the provision of Internet access. Some Customers will not have access to the Internet or the required hardware, software, Internet service provider relationship or expertise. The independent Facilitating Entity may facilitate the purchase of such needed goods or services by establishing a relationship with an information services consultant on a discounted basis based upon preferred access to the Customers C needing such services.

The independent Facilitating Entity may also establish a rewards program for Customers, through which benefits are earned by Customers or their individual Employees (e.g., frequent flyer miles, promotional goods, rebates) as a function of the amount of purchases made by the Customer or individual Employee or user using the SX system. Such a program can provide a further enticement to Customers to use the SX system and deepen the affinity of Customers and Employees or buyer for the Business Partner.

As also illustrated in FIG. 2, the independent Facilitating Entity may negotiate with employee services or employee benefits providers to enable Employees to obtain discounted access to desirable employee benefits. As seen in FIG. 1, a given Customer 15 may, prior to application of the inventive business method, provide services or benefits to its Employees E, through an employee services provider (ESP) 21. Owing to the size of the Customer 15 and its number of Employees, such services are not likely to be available at a discount to Customer 15. However, after application of the inventive business method, the independent Facilitating Entity may be able to negotiate with ESP 21, or with a competitive ESP, to have preferred status to supply employee services or benefits to the employees of all Customers C, rather than just Customer 15. The prospect of accessing such a large aggregate pool of employees without the normally attendant advertising expense, likely will be reflected by reduced pricing from ESP 21 for Products that was previously unavailable to Customers C. In exchange for providing access to this large group of employees, ESP 21 will likely be willing to pay a finder's fee or commission payable to the independent Facilitating Entity, which may or may not be then shared in whole or in part with Business Partners 12 and 14.

After establishment of the network of relationships illustrated in FIG. 2, the system may be readily expanded by the inclusion of additional Business Partners and their Customers, or the addition of horizontal or vertical Suppliers. It is believed that such growth will be readily achieved once the system reaches a critical mass of Suppliers, partners and Customers. As the system grows, the increasing pool of available Customers will facilitate further growth as a result of the increasing Customer base available to prospective Suppliers. Furthermore, it is anticipated that as more Customers join the network, the cost of service the Customers will decrease, warranting further price reductions from existing Suppliers, or such Suppliers may be forced to lower their prices to meet competition, which may be realized as further savings passed through to Customer prices, increased commission payments to the independent Facilitating Entity and/or Business Partners, or both.

It is anticipated that, once the system is established, the independent Facilitating Entity may negotiate with additional Customer pools to participate in the SX system and access goods and services available from the Suppliers S. The arrangements between the independent Facilitating Entity, SX system, and such additional Customers would be similar to that of a traditional buyer's organization, with the difference that an extraordinarily wide variety of Products would be available through the SX system as compared to other buyer's organizations. Furthermore, the SX system would provide a facility for buying goods and services from Suppliers in a uniform manner and without administrative overhead attributable to obtaining preferred pricing, neither of which are provided by conventional buyer's organizations.

Within this structure, the process used by a Customer to purchase goods and services, can be summarized as follows. The Customer will begin by subscribing to the SX system through their Business Partner, typically during a regular sales call by Business Partner sale personnel. In response, users, typically the Customer's Employees responsible for purchases, will be provided with unique login names and passwords. To make a purchase, a user will access either the Business Partner's web site or directly access the web site of the SX system. The Customer will then login, and may commence making purchases. Purchases from the Business Partner are made directly from the Business Partner via the partner's web site and e-commerce system or by other means. Purchases from participating Suppliers are made via the SX system. A Customer that has entered the Business Partner's web site may activate a link in that web site to be directed to the SX system web site to make purchases there. A common username and password can be used by both systems so that a user from either system is only required to login once.

Once a Customer makes a purchase from the SX system, a purchase requisition is created and the order is automatically forwarded to the Supplier for the good or service. The Supplier receives the order and fulfills it by shipping the Product directly to the Customer's shipping address. The Supplier retains title to the goods until shipment is completed, at which time title is transferred to the Customer. The Facilitating Entity SX System and Business Partner are not involved in the transaction as principal. The independent Facilitating Entity is involved only as an agent. Accordingly, the Supplier will look to the Customer for payment and the Customer will render payment directly to the Supplier.

The Customer will have the option to tender payment in various forms. For example, the Customer can use a credit card or purchasing card, purchasing credit account, or request a direct invoice from the Supplier. In any event, the independent Facilitating Entity, Business Partners and SX system will not manage the receivables or payables between the Supplier and consumer.

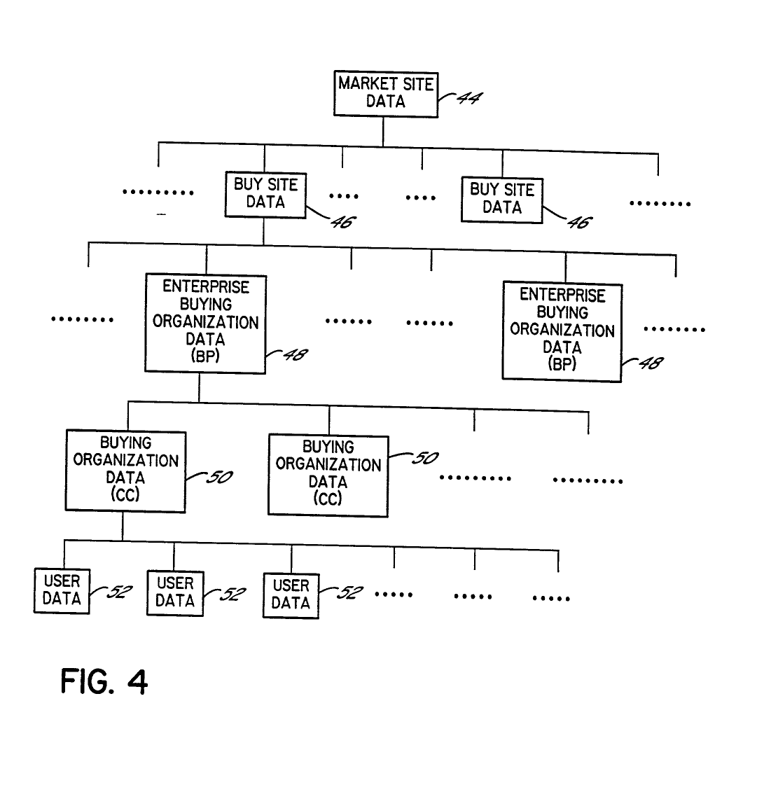

Referring now to FIG. 3, an explanation can be given of one implementation of the SX system in accordance with principles of the present invention. This implementation utilizes commercially available software and systems provided by CommerceOne, Inc. a Delaware corporation having its offices at 1600 Riviera Avenue, Walnut Creek, Calif. 94596. CommerceOne provides numerous clients with software for orchestrating an e-commerce business, having two main components. A first component is a buy site 30, using CommerceOne software, running upon hardware resources of the independent Facilitating Entity and administered by the independent Facilitating Entity in conjunction with CommerceOne. The buy site software may be used to establish a complete e-commerce server including Product search, browse, purchase, and order tracking capabilities, and may be modified or customized as is the case with the implementation of the present invention that is described herein.

The second component of the CommerceOne system is a market site 32, using CommerceOne software, running upon hardware resources of CommerceOne and administered by CommerceOne. The market site software provides “back office” services for the buy sites of the assorted CommerceOne clients, including the independent Facilitating Entity. The market site 32 includes a comprehensive database of price and Product Information for all Products offered by buy sites of CommerceOne clients. Each client's buy site 30 accesses pricing and Product images or other Product Information from the CommerceOne market site 32 and used this Information to present a Product catalog to Users of the buy site 30. Customers then generate purchases interacting with the buy site 30 and Information on these purchases is delivered to the market site 32 from the buy site 30. Market site 32 is accessed by Suppliers S through their computer systems and Internet sites 34, to upload pricing Information as well as Product images and purchase/shipment status or other Information, and download purchases made by Customers at buy site 30. Market site 32 is also accessed by buy site 30 to deliver purchases to market site 32 and receive pricing and Product Information as well as purchase/shipment status available at market site 32 from Supplier sites 34.

Buy site 30 is accessed by users U 38, typically Employees of Customers C, and typically through the computer systems and Internet site 36 of the Customers C, to place orders for Products. (Users U 38 may also interface the buy site 30 through any public Internet access, such as a personal Internet account available at a private home. Furthermore, users U 38 need not necessarily be Employees of customers C, buy can be any persons authorized to make or facilitate purchases for customers C.) In accordance with principles of the present invention, this access is made through a proprietary Customer interface 40, comprising an Internet server application interacting with the browser software of a Customer at a Customer site 36. This proprietary interface 40 is established for the SX system to facilitate the unique relationships between the independent Facilitating Entity, Customers, Business Partners, and Supplier Products available through the buy site 30, as detailed further below.

As can be seen in FIG. 3, each Business Partner has its own site 42 at which it receives orders from Customers C and, for those Customers wishing to purchase goods from Suppliers S through the SX system, provides referrals to Customer interface 40 and buy site 30. Business Partners receive from buy site 30, sales reporting Information usable to compute commissions earned or for other purposes such as marketing the system to Customers C of the Business Partner.

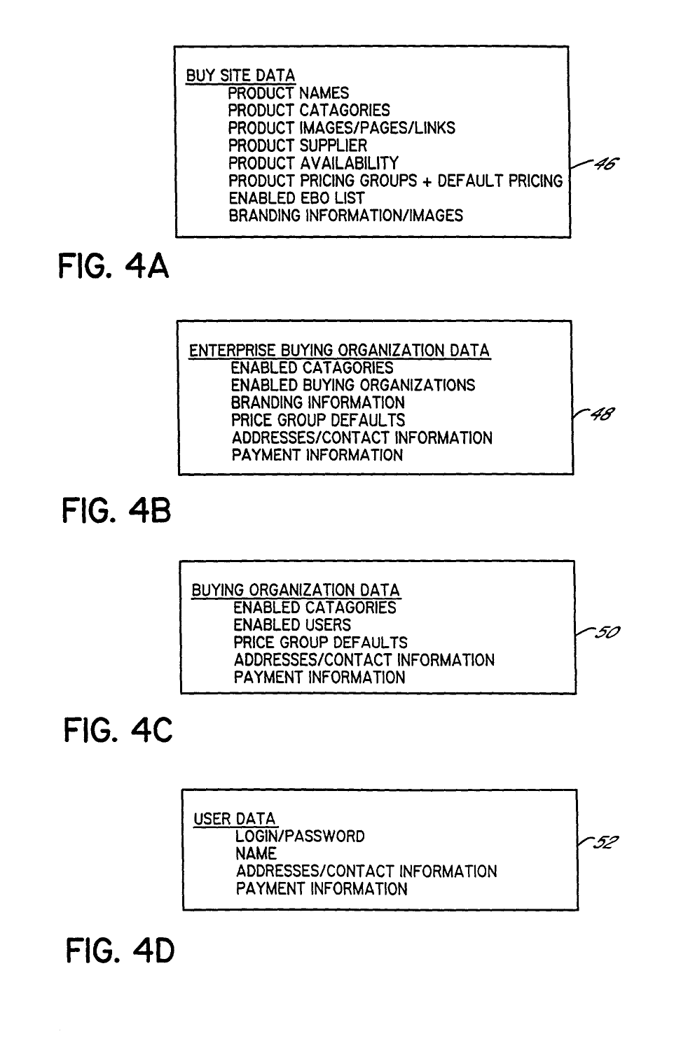

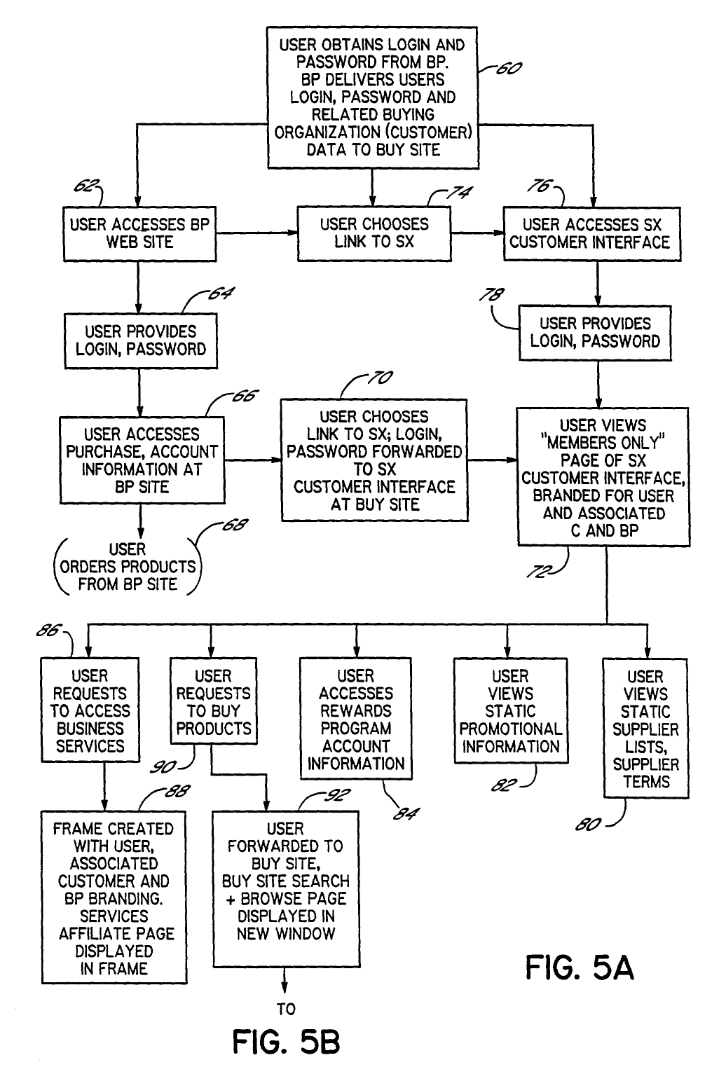

Referring now to FIGS. 4, 4A, 4B, 4C and 4D, the data used and administered by buy site 30 and market site 32 can be further explained. The CommerceOne software establishes a hierarchical arrangement of data pertaining to Products, Business Partners, Customers and Users, as illustrated in FIG. 4. The intended use of this data structure, as established by CommerceOne, varies from its use in accordance with principles of the present invention; FIG. 4 references the CommerceOne names for the various hierarchical Information, and cross-references its use in accordance with principles of the present invention.

A first level of Information is the market site data discussed above, which includes Information such as Product images, useable by the buy site 30 to facilitate purchases.

The second level of Information, detailed in FIG. 4A, is buy site data 46 describing the buy site 30. This data includes Product names, categories, and images, pages or links for Product Information. Also provided are Supplier Information, Product availability Information, pricing groups and default pricing for Products. Some or all of this Information may be obtained from the market site data 44 noted above. Additional Information includes a list of enabled “enterprise buying organizations” (EBO's), and branding Information and images applicable to the buy site. The list of enabled EBO's identifies the Business Partner/Customer groups that are currently able to access and purchase Products at the buy site, as further detailed in the EBO data 48, buying organization data 50 and User data 52. In the present application of the CommerceOne software, the branding Information and images refer include proprietary “sourceXplorer.com” and Business Partner trademarks and logos, that will be displayed to Users during interaction with the buy site 30.

The next hierarchical layer of Information is enterprise buying organization (EBO) data 48 (FIG. 4B), which in the present application is associated with a given Business Partner. This data includes a list of enabled Product categories. As noted above, Products are assigned to categories in the buy site data 46; the list established in the EBO data identifies those Products that will be available to be purchased by the Customers of a given Business Partner. Also included is a list of enables “buying organizations” (BO's), which identifies the Customers of the Business Partner that are currently able to purchase Products at the buy site 30. Also included is branding Information for the EBO, which in the present application of the CommerceOne software includes trademarks and logos of the Business Partners, which are displayed to Customers of that Business Partner when those Customer's access the buy site 30. The EBO data 48 also includes price groups defaults, indicating the default price groups, from among those groups defined by a Supplier and available in the buy site data 46, that are by default available to Customers of the associated Business Partner. In addition, address and contact Information may be stored in the EBO data 48, in case there is a default address that is applicable to multiple Customers of a given Business Partner, e.g., the shipping address of the Business Partner. Finally, payment Information may be stored in the EBO data 48, in the unlikely case there is default payment methods that are applicable to multiple Customers of a given Business Partner.

The next level of Information is the buying organization 50 (FIG. 4C), which is used to store Information specific to a Customer, which overrides the default list provided in the EBO data 48. This permits a given Customer to have access to browse and purchase a larger or smaller group of Supplier Products than other Customers of the same Business Partner, if desired by the Business Partner. The BO data 50 further included a list of enabled Users, identifying those Users able to make purchases on behalf of a Customer. Price group defaults are also provided, to override the price group default set by the EBO data 48, so that a given Customer may be provided different pricing than other Customers, if desired by a Supplier or Business Partner. Address and contact Information, and payment method Information is also provided, so that a Customer may have established default shipping or contact addresses and default payment methods that are available to all Users.

The final hierarchical level is User data 52 (FIG. 4D). This data is specific to an individual User and that User's interaction with the buy site 30. The Information stored for a User includes the login and password used to validate the User's identity, the User's name for greeting the User and thus “branding” pages at the buy site that are viewed by the User, address and contact Information that is specific to the User, e.g., that User's personal shipping address, and finally, payment Information that is specific to the User, e.g., that User's personal corporate credit card, purchasing card or purchasing credit account number.

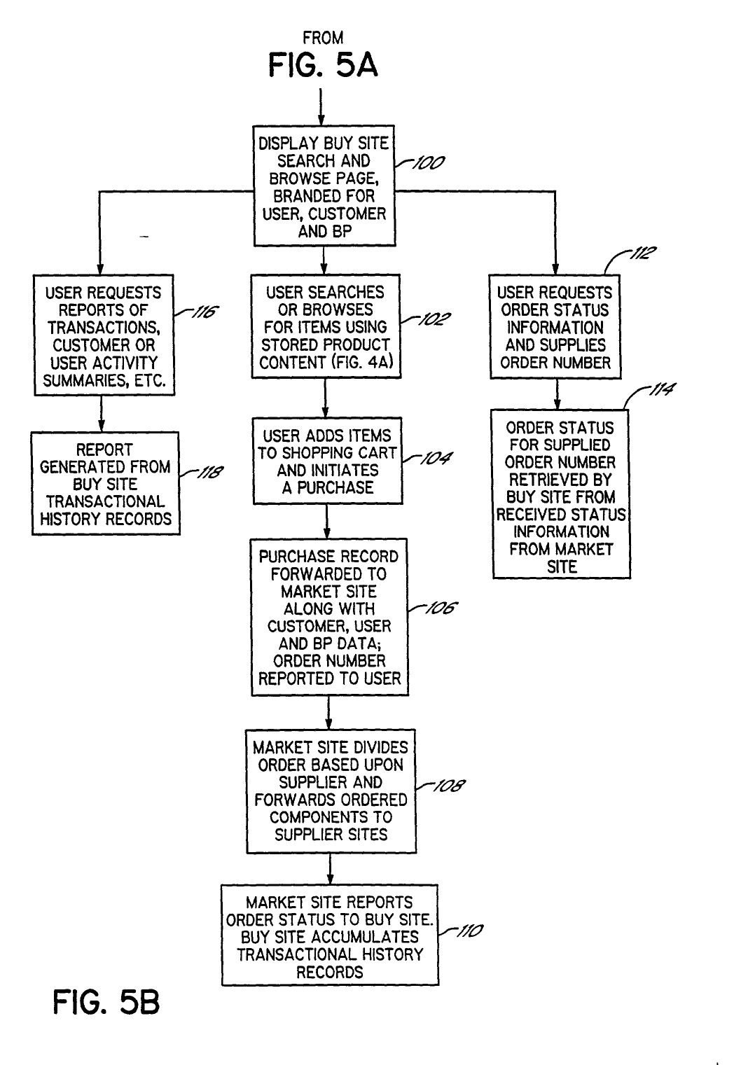

The information described in the preceding paragraphs is used by the buy site software 30 and Customer interface 40 in interacting with a Customer as described in FIGS. 5A and 5B. As noted above, this process begins in step 60 when a User obtains a login and password from their affiliated Business Partner, and the Business Partner delivers the assigned login and password, and related buying organization data (if the Customer has not already been established as a buying organization) to the SX system buy site. Subsequently, the User can then use the SX system and the partner's own e-commerce system to make electronic purchases.

A first option available to a Customer is to access the Business Partner's web site in step 62. Doing so permits the Customer to login to the Business Partner's internal server in step 64, and thereby in step 66 access and view purchase and account Information relating to the Customer's purchases from the Business Partner, as well as, in step 68, make new purchases directly from the Business Partner.

While viewing the Business Partner's web site in step 66, the User will be presented with a link leading to the SX system at the buy site 30. If, in step 70, the User chooses this link, the login and password provided by the User will be forwarded to the SX Customer interface 40 at the buy site 30. Subsequently, in step 72, the Customer will view the “members only” page of the SX Customer interface, which will be branded (using User, EBO and BO data) for the User and the associated Customer and Business Partner.

The User may also access the “members only” page via other paths. For example, the User may choose (step 74) a link to the SX system at the Business Partners home page is step 62, before logging into the Business Partner's e-commerce system. In this case, in step 76 the User is presented with the home page of the Customer interface 40 of the buy site 30. The User may then, in step 78, provide the assigned login and password to be transferred to the “members only” page of step 72, discussed above.

A third path a User may take into the SX system, is to directly access the home page of the SX system by entering the appropriate uniform resource locator (URL) for this page, and thus begin directly at step 76. The User can then login as described above in step 78.

Once a User has successfully logged into the system and is at the “members only” page of step 72, the User may invoke a number of interactions with the Customer interface software 40 of the buy site. For example, the User may, in step 80, view static Supplier lists and Supplier terms for those Suppliers accessible through the SX system. Also, the User may, in step 82, view static promotional Information, which may, for example, identify a “product of the week” begin offered currently by the Supplier at a special discount price. The User may further, in step 84, access rewards program Information, general account Information or other static Information available from the Customer interface software 40.

Users may also be provided with referrals to business services such as financial institutions, employee services providers, or other services affiliated with the Business Partner. Such referrals, when requested in step 86, are provided in step 88 in the form of a framed hypertext markup language (HTML) document, where the frame reflects the SX branding including the Business Partner and Customer identifications, and the interior of the frame is a description of services or other solicitation of the affiliated service provider.

In addition to the foregoing, a User may also purchase Products from affiliated Suppliers. This is done by requesting, in step 90, to make purchases, in response to which the User is forwarded to the CommerceOne buy site software, and a new browser window is opened displaying the buy site search and browse page. (The User is at this point already logged into the CommerceOne buy site by virtue of previously supplying a username and password.) Subsequently, in step 94, the User may browse, make purchases, or view status Information by interacting with the buy site pages.

Referring now to FIG. 5B, the specific interactions between a User and the CommerceOne buy site software can be detailed. As noted above, all interactions are initiated from (step 100) the buy site search and browse page, in which Product categories and other action alternatives are identified.

A first action the User may take is, in step 102, to search and browse for items to be purchased, using the stored Product content discussed above with reference to FIG. 4A. Upon finding a desired item, in step 104 the User adds the item to a shopping cart, and subsequently initiates a purchase of the item. In step 106, a purchase record is forwarded from the buy site 30 to the market site 32 for the item(s) in the User's shopping cart. Included in the purchase record is the Customer, User and Business Partner data, for use in later tracking. An order number is established and returned to the User. In a subsequent step 108, the market site 32 processes the order by dividing it based upon the Supplier for each item, and then forwards the ordered components to the Supplier sites 34, initiating the fulfillment of the order by the Suppliers. In step 110, the market site receives regular updates on the status of the order and accumulates transactional history records that can be subsequently used in providing reports.

Such status reports are another action that can be requested from the search and browse page. Specifically, in step 112, the User can request order status for orders placed through the SX system. To obtain such status, the order number given in step 106 must be provided. In response, in step 114, the order status for the supplied order number is retrieved by the buy site software, from the accumulated status Information received from the market site 32, and the resulting status is presented to the User.

A third activity that can be requested, in step 116, is requesting reports of historic transactions, Customer or User activity summaries. These reports are also generated, in step 118 from the transactional history records accumulated by the buy site from received status Information.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A method by which third parties facilitate the conduct of business between buyers and sellers of products, comprising:
negotiating arrangements between a facilitating entity and at least one supplier, for said supplier to provide products to customers of a business partner at negotiated prices, said business partner also individually providing goods or services to said customers other than the products provided by said supplier.

2. The method of claim 1 wherein said arrangements stipulate that only parties that are customers of the business partner are provided access to the prices negotiated by the facilitating entity.

3. The method of claim 1 wherein the service of negotiating said arrangements is performed by the facilitating entity.

4. The method of claim 3 wherein said service of negotiating said arrangements is provided to said customers free of direct charge.

5. The method of claim 3 further comprising transferring fees from said customers to said facilitating entity for said service of negotiating said arrangements.

6. The method of claim 1 further comprising providing an information processing system for facilitating the purchase of products by customers from said suppliers via a common electronic access point.

7. The method of claim 1 wherein said arrangements include payment of commissions to the facilitating entity and/or business partner for products sold to said customers.

8. The method of claim 7 wherein at least a part of commission revenue resulting from a supplier sale to a customer is paid to the business partner responsible for the inclusion of said customer in said arrangements.

9. The method of claim 7 wherein commissions are divided among the facilitating entity and business.

10. The method of claim 9 wherein there is a plurality of business partners, and commissions are divided among the business partners on a prorata basis based upon sales to customers or the number of customers of each business partner included in said arrangements.

11. The method of claim 1 wherein the products provided by said supplier are indirect goods and services that are not used in the production of goods and services by the customers.

12. The method of claim 1 wherein the products provided by said suppliers are direct goods and services that are used by customers in the production of goods and services.

13. The method of claim 1 wherein there is a plurality of business partners said suppliers are suppliers to a horizontal market that may include customers of a plurality of said business partners.

14. The method of claim 1 wherein there is a plurality of business partners and said suppliers are suppliers to a vertical market that primarily includes only customers of one of the business partners.

15. The method of claim 1 further comprising
negotiating arrangements with an employee services provider to provide employee services or benefits to employees of said customers.

16. The method of claim 15 wherein said employee services provider provides access to employee health insurance.

17. The method of claim 15 wherein said employee services provider provides access to discounted entertainment or travel.

18. The method of claim 1 wherein said arrangements provides discounted pricing of said supplier to all customers of said business without restriction.

19. The method of claim 1 wherein said arrangements establish criteria upon customers for discount eligibility.

20. The method of claim 19 wherein said criteria include meeting credit requirements.

21. The method of claim 19 wherein said criteria are established uniformly for all customers.

22. The method of claim 19 wherein said criteria are established by said business partner and are applicable only to customers of that business partner.

23. The method of claim 1 further comprising
including one or more additional business partners in said arrangements, such that said supplier provides discounted pricing to customers of said additional business partners.

24. The method of claim 23 further comprising
including one or more additional suppliers in said arrangements, such that discounted pricing from said additional suppliers is available to said customers.

25. The method of claim 24 wherein one of said suppliers is converted to a business partner, such that customers of said supplier are able to access discounted pricing that has been negotiated with other suppliers.

26. The method of claim 1 wherein said facilitating entity is independent of said business partners.

27. A system for conducting business between buyers and sellers of products, administered by a facilitating entity, comprising:
entering an order for a product electronically, whereby said order is entered by a user of a customer of a business partner for a product of a supplier at an established price;
whereby a facilitating entity:
(1) selects the business partners and suppliers who participate in the system;
(2) provides a means by which a user can access information about products of suppliers;
(3) negotiates established prices for products with the suppliers; and
(4) stores and processes information that can be used to facilitate the business among the participants of the system.

28. The system of claim 27 wherein said facilitating entity is independent of said business partners.

29. The system of claim 27 wherein said facilitating entity enrolls customers and users for participation in the system.

30. A system for conducting business between buyers and sellers of products, administered by a facilitating entity, comprising:
entering an order for a product electronically, whereby said order is entered by a user of a customer of a business partner for a product of a supplier at an established price;
whereby a facilitating entity:
(1) selects the business partners and suppliers who participate in the system;
(2) provides a means by which an individual employed by a participant in the system, can access employee benefits or discounts;
(3) negotiates established prices for employee benefits or discounts with the suppliers; and
(4) stores and processes information that can be used to facilitate the business among the participants of the system.

31. A system for conducting business between buyers and sellers of products, administered by a facilitating entity, comprising:
entering an order for a product electronically, whereby said order is entered by a user of a customer of a facilitating entity for a product of a supplier at an established price;
whereby said facilitating entity:
(1) selects the customers who participate in the system;
(2) provides a means by which a user can access information about products of suppliers;
(3) negotiates established prices for products with the suppliers; and
(4) stores and processes information that can be used to facilitate the business among the participants of the system.

32. A method by which a third party facilitates the conduct of business between buyers and sellers of products, comprising:
negotiating arrangements between customers of a business partner and at least one supplier, for said supplier to provide products to customers of said business partner at negotiated prices, said business partner also individually providing goods or services to said customers other than the products provided by said supplier.

33. The method of claim 32 wherein said arrangements stipulate that only parties that are customers of the business partner are provided access to the prices negotiated by the facilitating entity.

34. The method of claim 32 wherein the service of negotiating said arrangements is performed by a facilitating entity affiliated with said business partner.

35. The method of claim 34 wherein said service of negotiating said arrangements is provided to said customers free of direct charge.

36. The method of claim 34 further comprising transferring fees from said customers to said facilitating entity for said service of negotiating said

37. The method of claim 32 further comprising providing an information processing system for facilitating the purchase of products by customers from said suppliers via a common electronic access point.

38. The method of claim 32 wherein said arrangements include payment of commissions to the business partner for products sold to said customers.

39. The method of claim 32 wherein the products provided by said supplier are indirect goods and services that are not used in the production of goods and services by the customers.

40. The method of claim 32 wherein the products provided by said suppliers are direct goods and services that are used by customers in the production of goods and services.

41. The method of claim 32 wherein said arrangements provides discounted pricing of said supplier to all customers of said business without restriction.

42. The method of claim 32 wherein said arrangements establish criteria upon customers for discount eligibility.

43. The method of claim 42 wherein said criteria include meeting credit requirements.

44. The method of claim 42 wherein said criteria are established uniformly for all customers.

45. The method of claim 32 further comprising
including one or more additional suppliers in said arrangements, such that discounted pricing from said additional suppliers is available to said customers.

46. A system for conducting business between buyers and sellers of products, administered by a facilitating entity, comprising:
entering an order for a product electronically, whereby said order is entered by a user of a customer of a business partner for a product of a supplier at an established price;
whereby a facilitating entity:
(1) is affiliated with said business partner;
(2) selects suppliers who participate in the system;
(3) provides a means by which a user can access information about products of suppliers;
(4) negotiates established prices for products with the suppliers; and
(5) stores and processes information that can be used to facilitate the business among the participants of the system.

47. The system of claim 46 wherein said facilitating entity enrolls customers and users for participation in the system.

48. A system for conducting business between buyers and sellers of products, administered by a facilitating entity, comprising:
entering an order for a product electronically, whereby said order is entered by a user of a customer of a business partner for a product of a supplier at an established price;
whereby a facilitating entity:
(1) is affiliated with said business partner;
(2) selects suppliers who participate in the system;
(3) provides a means by which an individual employed by a participant in the system, can access employee benefits or discounts;
(4) negotiates established prices for employee benefits or discounts with the suppliers; and
(5) stores and processes information that can be used to facilitate the business among the participants of the system.
